(19) United States
(12) Patent Application Publication
(10) Pub. No.: US 2009/0034253 A1
(43) Pub. Date: Feb. 5, 2009

(54) Luminaire

(76) Inventor: Hartmut S. Engel, Ludwigsburg (DE)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 12/184,454

(22) Filed: Aug. 1, 2008

(30) Foreign Application Priority Data
Aug. 2, 2007 (EP) 07 015 209.5

(51) Int. Cl. F21V 7/00

(52) U.S. Cl. 362/245

(57) ABSTRACT

A luminaire is described having a pot-shaped housing for the mounting of illuminants and associated electrical components as well as for the shape matched reception and releasable fastening of a luminaire member, wherein the luminaire is characterized in that the luminaire member includes a first base region corresponding at least substantially to an axial extension of the housing and an external region adjoining it which expands continuously, starting from the base region, in the form of a slanted surface and merges into a central axis of the luminaire body approximately perpendicular to the luminaire member; and in that the illuminant or illuminants is or are positioned and/or designed such that both the base region and the front surface are illuminated with direct light of the illuminants substantially over their full area and the slanted surface is substantially only disposed in the sidelight region.

### CROSS-REFERENCE TO RELATED APPLICATIONS

This application claims priority to European Application No. 07 015 209.5, filed Aug. 2, 2007 the disclosure of which is herein incorporated by reference.

The invention relates to a luminaire comprising a pot-shaped housing which has a base surface and a peripheral wall, and on which illuminants and associated electrical components are mounted and into which a light-permeable luminaire member engages in a shape-matched manner and is releasably fastened to the housing.

Luminaires of this kind are known and are used both in the indoor area and in the outdoor area.

An illuminant in the form of a light bulb is known from US 2003/201704 A1 which is preferably provided with a screw base and which has a halogen bulb as the light source which is arranged behind a lens simultaneously serving as protection against explosion in the housing region of the lamp. The lens is held in a ring component which simultaneously serves for the fastening of a luminaire member which preferably consists of glass and whose inner wall is provided with a reflective coating. The light generated by the halogen bulb is directed directly and also via a reflector disposed at the rear with respect to the halogen bulb toward the reflective inner coating of the luminaire member and is also directed to the light permeable closing wall of the luminaire member so that the total light generated by the halogen bulb exits at the front side of the luminaire member and not in the lateral area.

A luminaire is known from DE 36 33 976 A1 which is limited laterally with respect to glare and which has a pulled down mirror reflector, with the lower rim of the mirror reflector having a light-scattering body. The light-scattering body, which is a prism or a reflective surface, is arranged directly adjacent to the ceiling construction within which the mirror reflector is located at whose base the illuminant, in particular a lamp or incandescent bulb, is positioned.

A light transmitting lens is known from U.S. Pat. No. 5,173,810 for use with a photoelectrical sensor, wherein a specially designed lens is provided in an approximately semi-spherical housing, in particular made of black plastic, said lens enabling the light transmitted by an LED arranged at the base side in the housing to be deflected such that a bundle of parallel light rays exits the front side of the housing and accordingly the whole light generated by the LED can be utilized.

A luminaire is known from WO 01/59365 A having a bulb and at least one concavely curved reflector which is arranged—seen in the direction of radiation—behind or laterally behind the lamp, with color filters being arranged to the side of the bulb such that only the light radiated from the lamp laterally toward the at least one concave reflector is changed in its color composition by the color filter, whereas the light radiated from the bulb in the direction of radiation is not changed by the color filter. In this respect, a rod-shaped gas discharge bulb is used as a light source which is arranged centrally between the lateral color filters and in front of which, in the room radiation direction, a light distribution element is arranged in the form of an array which comprises side reflectors and transverse lamellae and via which a large portion of the light emitted by the bulb is radiated downwardly. Alternatively, instead of an array, a perforated metal sheet or another optical element can be provided in the form of a diffuser or of a prism structure. In all embodiments, the region surrounding the bulb appears in a different color so that different effects and moods can be generated by the selection of a suitable filter.

It is the object of the present invention to design luminaires of the initially named kind in a technical light respect and in a constructionally simple and universally usable manner while simultaneously providing a distinctive esthetic appearance such that direct light free of glare over a large area is obtained, on the one hand, and at least one radial indirect light portion is obtained, on the other hand.

This object is satisfied by the interaction of the features of claim 1.

It is possible in an effective manner thanks to the special shape of the luminaire member and the direct positioning of the illuminants to apply direct light uniformly to the substantially planar front surface, on the one hand, and to design the light density differences between the front surface and the slanted surface, on the other hand, such that a radial light region arises between the slanted surface and the housing which delivers an indirect light portion and which can appear in an emphasized manner and differentiated from the front surface delivering the direct light due to the slanted surface having a lower light density.

The radial light section is preferably obtained in that the base region of the luminaire member has a fastening section engaging into the pot-shaped housing and a section disposed between the fastening section and the slanted surface which is light permeable and to which direct light is applied.

It is important for the technical light function of the luminaire in accordance with the invention that the reception region for the illuminant or illuminants is disposed beneath the cross-sectional plane of the luminaire member corresponding to the start of the slanted surface and preferably beneath the cross-sectional plane of the luminaire member corresponding to the start of the light permeable section connected before the slanted surface since this is an important requirement for the characteristic application of direct light or sidelight to the different regions of the luminaire member.

In accordance with an advantageous embodiment of the invention, the axial height of the radial light section is smaller than the axial height of the slanted surface section extending up to the front surface, with the axial height of the radial light section amounting to approximately 30% to 60% of the height of the slanted surface section in preferred embodiments. In this connection, the slanted surface preferably includes an angle of less than 50° with the base surface of the housing and this angle is advantageously in the range from approximately 25° to 45°.

The transition between the fastening section and the light permeable section delivering the radial light is expediently designed in the form of a step which is associated with an increase in diameter and which is in particular at a right angle.

It can be achieved in this manner that the luminaire member and the housing engage into one another in an outwardly coinciding manner such that the radial light section is clearly delineated visually, and indeed, on the one hand, by the housing and, on the other hand, by the slanted surface only disposed in the sidelight region.

In accordance with an advantageous aspect of the invention, in particular with a round luminaire, a hexagonal element, in particular a ring plate, is positioned in the region of the radial light section and with a presettable axial spacing with respect to the slanted surface, said ring plate extending at least substantially parallel to the front surface and its diameter being larger than the diameter of the front surface.

Since this ring plate is disposed in the radial light region, a lighting surface is provided at a spacing from the fully illuminated front surface which is set back with respect to the front surface and which both results in a particularly characteristic appearance of the luminaire in an esthetic respect and produces a desired additional benefit in a technical light respect which is also above all developed when the radially inner region of the ring plate is made as an at least partly open, light permeable region and the fastening region for the luminaire disposed to the rear of the plate can then be illuminated.

The ring plate can preferably be connected to the housing via coupling elements so that it can be attached to the basic embodiment of the luminaire as required at any time. It is equally possible to form the ring plate as the top wall of a ring space at least partly surrounding the housing, with the ring space formed in this manner being able to be utilized for the reception of functional components such as ballast or a motion detector.

A particularly preferred embodiment of the invention is characterized by an aspect in the form of a built-in luminaire flush with the ceiling or wall and having a reflector pot which surrounds the luminaire member at all sides with a radial spacing and whose opening plane extends at least substantially in accordance with the plane of the front surface of the luminaire member.

In this respect, the reflector pot either has a base surface which extends at a presettable angle or approximately parallel to the slanted surface of the luminaire member and which merges into a vertical wall section in the vertical region of the slanted surface or it has a base surface which is disposed in the region of the housing base, which extends radially outwardly, which ends within the vertical projection of the front surface and which is adjoined by a slanted wall region which in turn merges into a vertical wall section. The slanted wall region of the reflector pot can be selected to be steeper or less steep than the slanted surface of the luminaire member in dependence on the desired light density distribution at the visible side.

With these embodiments of the invention, the radial light portion is defected via the reflector pot in a manner such that the light radiation surface of the luminaire member is increased by characteristically directed diffuse light and an increased esthetic differentiation for the use as general illumination without special anti-glare aspirations is obtained by the different light densities in the region of the luminaire member and in the region of the reflector pot.

It is furthermore of particular advantage in this respect that due to reflections and scatter effects by the interaction of slanted surfaces of the luminaire member and of oppositely disposed reflector pot walls, all shadow effects are avoided in the base region of the reflector pot and the reflector pot is illuminated over a full area, i.e. also in its base region, which is not only advantageous from a technical light aspect, but also substantially improves the overall esthetic impression of the luminaire.

An embodiment of the invention which is particularly advantageous with respect to the achievable light yield and which can be used both in the case of round luminaires and in the case of rectangular luminaires is characterized in that the luminaire member is not made in one piece, but consists of a plurality of parts which are in particular adhesively bonded or welded to one another, with at least the front surface including a layer structure with a microprism screen whose outwardly disposed prisms are covered by an outer surface preferably as clear as glass and at whose inner side a diffusion foil is preferably provided. This layer structure forming the front surface is expediently connected in a shape matched manner directly or via a frame enclosing the layer structure to a matched end section of the luminaire member and both parts are in particular welded together. The region of the luminaire member adjoining the front surface and preferably formed by the end section of the luminaire member is made as a peripheral lighting surface in this respect.

The use of the mentioned layer structure results, in comparison with an embodiment in opal glass or in a corresponding plastic material, in a substantial increase in the light yield, amounting to up to 50%, for example.

In particular ring-shaped or rod-shaped fluorescent lamps or compact fluorescent lamps having a plurality of light rods can be used as illuminants both in the case of a round embodiment and of a rectangular embodiment of the luminaire.

The LED light technology can equally be used in an energy efficient manner in that a plurality of LEDs are attached to at least one support surface, which is preferably reflective, and the support surface is positioned in the region of the radial light section of the luminaire member at the housing side. The respectively desired light color can be ensured by the use of commercial LEDs, with an RGB illumination also being possible by a corresponding equipping.

The luminaire member is preferably couplable to the housing via a plurality of over center lever clamps supported at the housing. These over center lever clamps not only permit a simple connection of both bodies which is also absolutely tight on the use of a seal between the luminaire member and the housing, but they also have the advantage that they can be activated without problem when the luminaire member is surrounded by a reflector pot since these clamps are also accessible via the intermediate space between the luminaire member and the reflector pot for actuation.

In accordance with a further embodiment of the invention, which, while maintaining all other advantages of the basic concept in accordance with the invention, is characterized by a particularly high light density achievable in the region of the front surface, a plurality of mutually spaced apart LEDs are provided as illuminants and are arranged in a plane parallel to the front surface of the luminaire member, with a special optical attachment being associated with each LED which effects both an axial bundling and a lateral radiation of the light, with the LEDs with associated optical attachment preferably being positioned in the base region or at least partially in the base region of the luminaire member.

The number and the distribution of the LEDs with the associated optical attachment is selected in this respect such that the axially directed light bundles obtained by the optical attachment illuminate the front surface over the full area, i.e. are incident onto the front surface substantially adjacent to one another or overlapping in their marginal regions. The direct light exiting the respective optical attachment is at least predominantly incident onto the radial light section of the luminaire so that in accordance with the basic principle of the invention the radial light section and the front surface are in turn illuminated with direct light.

The invention will be explained in the following with reference to embodiments and to the drawings; there are shown in the drawings:

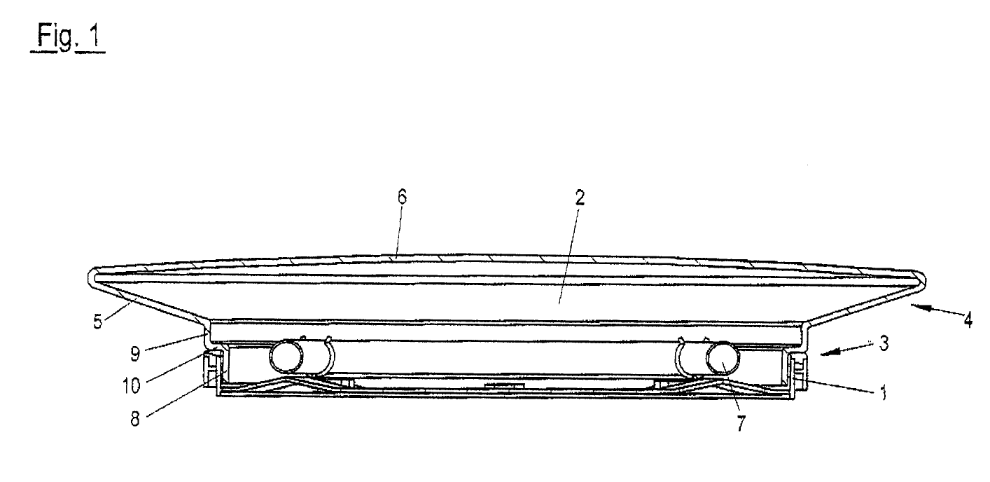

FIG. 1 a schematic sectional view of a basic embodiment of a luminaire in accordance with the invention;

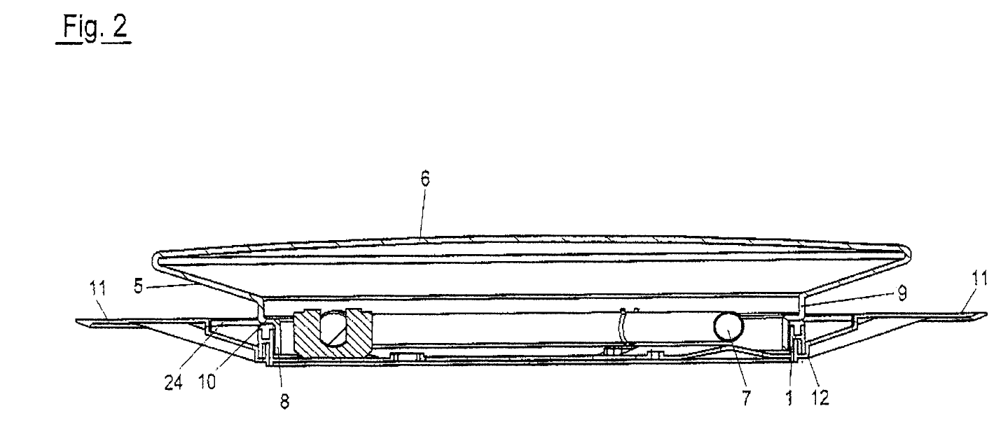

FIG. 2 a sectional view of a variant of the luminaire in accordance with FIG. 1;

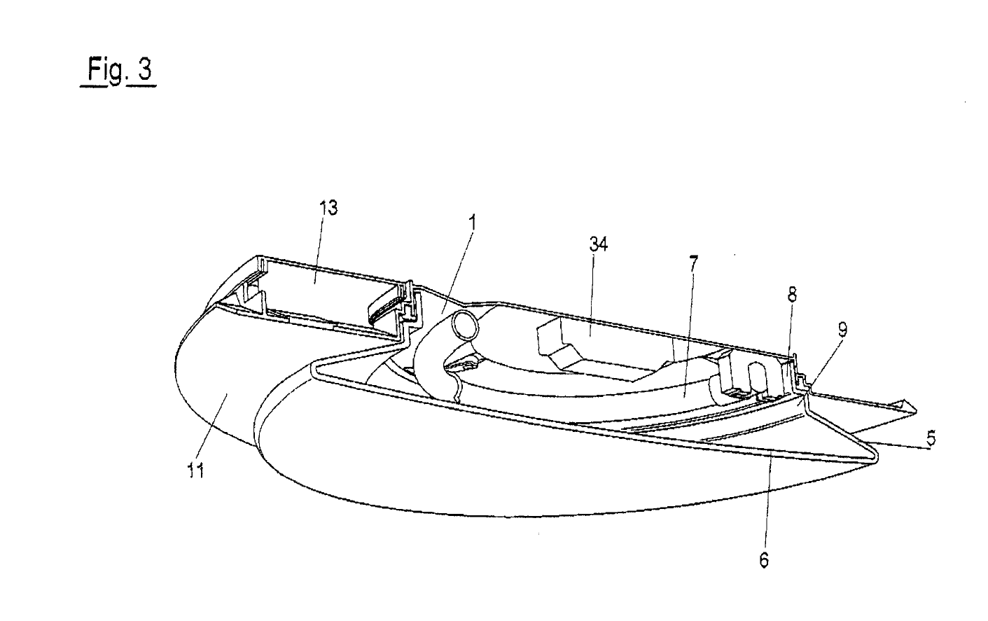

FIG. 3 a perspective sectional view of a further embodiment of the luminaire in accordance with the invention;

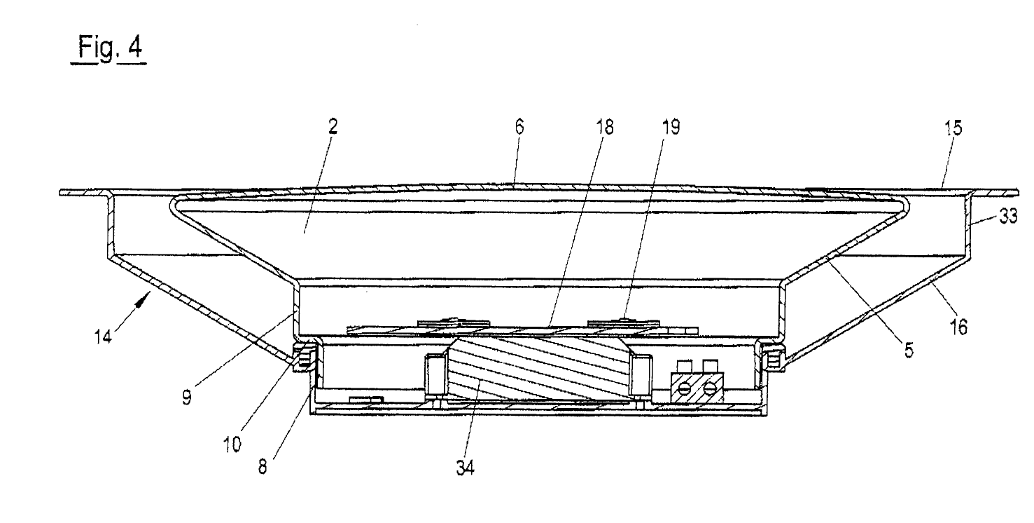

FIG. 4 a schematic sectional view of an embodiment of the invention designed as a built-in lamp;

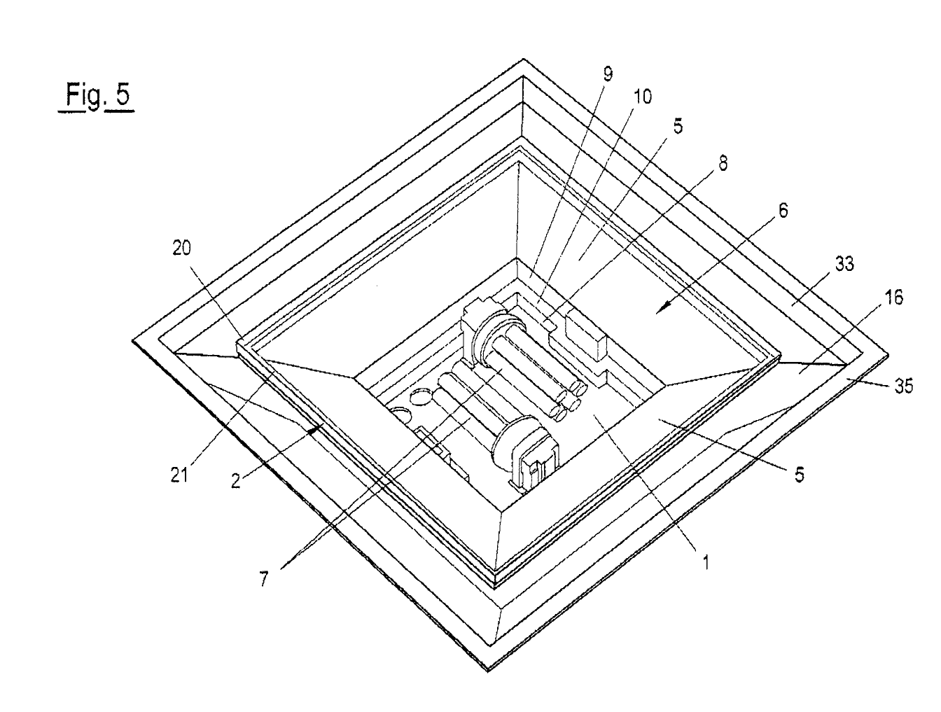

FIG. 5 a perspective view of an embodiment in a built-in version with compact fluorescent lamps, with the luminaire having a rectangular shape;

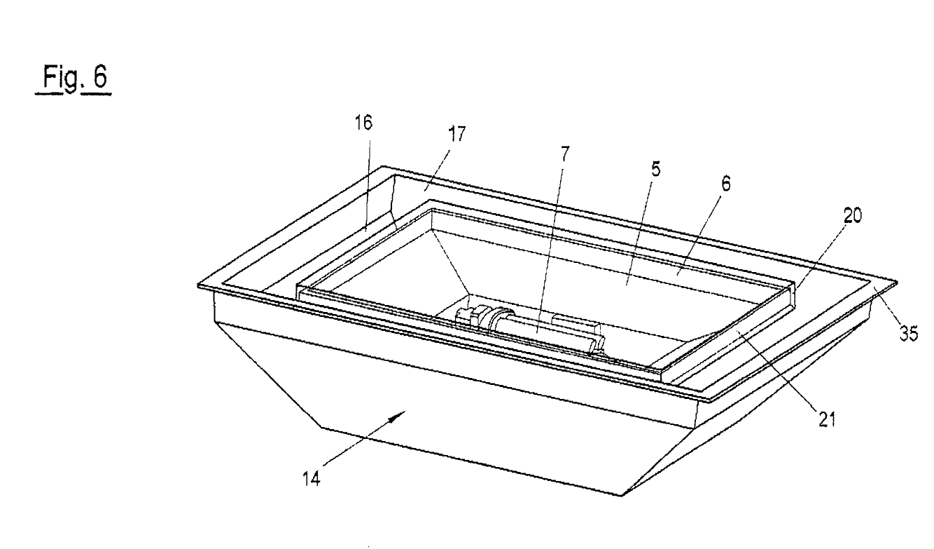

FIG. 6 a perspective oblique view of a rectangular luminaire in the form of a built-in variant;

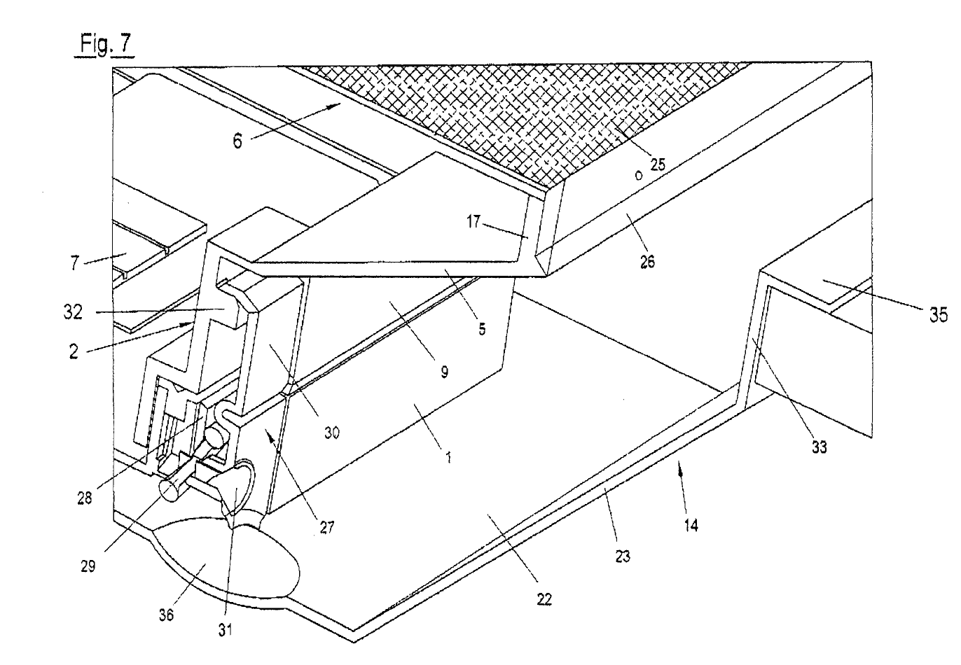

FIG. 7 a perspective partial sectional view of the rectangular luminaire in accordance with FIG. 6; and

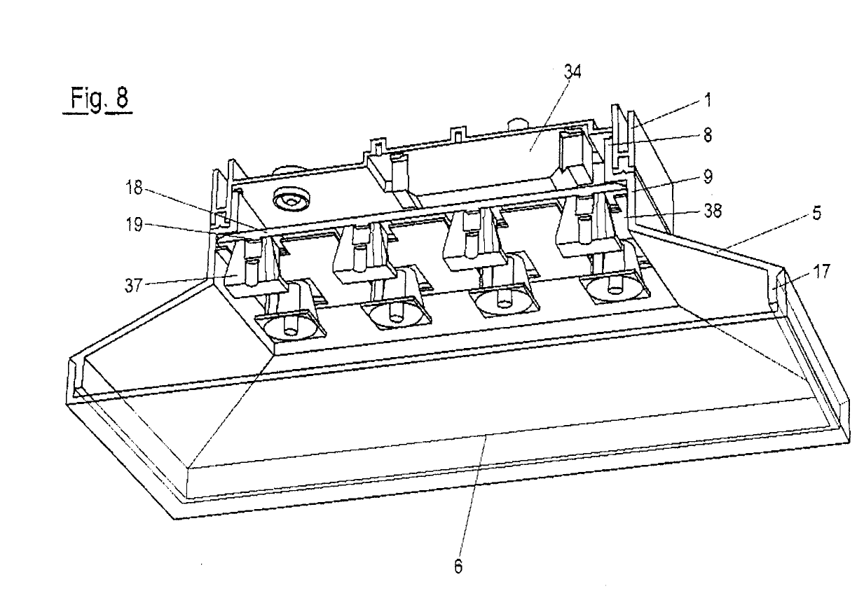

FIG. 8 a partial sectional view of a further embodiment of a luminaire in accordance with the invention with a plurality of LEDs interacting with an additional optical system.

FIG. 1 shows the basic structure of a luminaire in accordance with the invention which includes a luminaire member 2 in particular comprising satined opal glass or a corresponding plastic as well as an associated pot-shaped housing 1.

The luminaire member 2 is formed by a base part marked by the general reference numeral 3 and an outer region 4, with the outer region 4 comprising an oblique surface region 5 and a front surface 6. The transition between the slanted surface region 5 and the essentially planar or only slightly outwardly curved front surface 6 takes place in the example shown via a curved region, with the front surface 6 and the slanted surface 5 extending at an acute angle to one another.

Instead of the transition between the slanted surface region 5 and the front surface 6 shown in FIG. 1, a cylindrical region of presettable height formed between the slanted surface region 5 and the front surface 6 can also be provided and, in contrast to the slanted light region 5, does not have sidelight applied to it, but above all direct light from the illuminants.

Toward the housing side, the slanted surface region 5 of the luminaire member 2 is followed by a radial light section 9 which merges via a transition step 10 into a fastening section 8 which engages into the housing I and is fixable to the housing 1.

The illuminant or illuminants 7 are designed and/or positioned such that both the base region 3 or the radial light section 9 and the front surface 6 is illuminated with direct light over substantially the whole surface and the slanted surface 5 of the luminaire member 2 is substantially only disposed in the sidelight region.

A substantial feature of the invention can be seen in the fact that the respectively used illuminants 7 are positioned at least beneath a plane which extends as an imaginary transverse plane through the start of the expanding slanted surface region 5.

In the example of a round luminaire shown, which is not restrictive with respect to the shape, a fluorescent lamp FC is used as the illuminant 7; however, depending on the dimensioning of the luminaire, instead of one fluorescent lamp two or more fluorescent lamps and also areal LED arrangements can also be used which are preferably disposed in the same plane.

The transition stage 10 between the radial light section 9 and the fastening section 10 of the luminaire member made of opal glass or of a suitable plastic material is selected and dimensioned such that the housing 1 extends outwardly flush with the radial light section 9, whereby a defined visual boundary of the radial light section 9 and a shape matched integration of the housing 1 into the total structure of the luminaire are also obtained.

In a functional respect, the radial light section 9 to which light is directly applied produces a defined portion of indirect light at the room side which appears in dependence on the inbuilt situation additionally to the direct light delivered by the front surface. The slanted surface 5, which is disposed over its full extend in the sidelight region of the light source 7, only appears in subordinate manner in a technical light aspect, but contributes to the clear differentiation between direct light and indirect light.

The axial height of the radial light section 9 is preferably smaller than the axial height of the slanted surface section extending up to the front surface 6 and it in particular amounts to approximately 30 to 80% of the height of the slanted surface section.

The slanted surface 5 includes an angle less than 50° with the base surface of the housing 1 and this angle is preferably in particular in the range from 25° to 45°.

The sectional view in accordance with FIG. 2 shows the embodiment in accordance with FIG. 1 supplemented by a ring plate 11 which is coupled to the housing 1, is positioned at the level of the transition step 10 and has a diameter which is much larger than the outer diameter of the front surface 6. Depending on which axial height is selected for the radial light section 9 in the respective embodiment of a luminaire in accordance with the invention, the ring plate 11 will have a more less high light density, which is, however, always lower in comparison with the front surface 6, so that the overall flat character of the luminaire is emphasized even more and it becomes possible to allow the front surface 6 to come even further to the fore by providing a kind of background lighting. This is, for example, of advantage when the front surface has a special marking such as a representation of a house number.

It proves advantageous in this embodiment variant for the radially inwardly disposed support region 24 of the ring plate 11 to be made as an at least partly open and light permeable region since, in this case, an illumination of the wall region serving for the fastening of the luminaire is additionally achieved via reflected light and scattered light.

FIG. 3 shows a further development of the luminaire in accordance with FIG. 2, with in this case the ring plate 11 being made as a top wall of a ring space 13 at least partly surrounding the housing 1. The elements required for the provision of the ring space are preferably shaped plastic elements which can be connected in a simple manner to corresponding coupling walls of the ring plate 11. The ring space provided in this manner preferably serves for the reception of functional elements such as ballast or a motion detector. Ballast 34 can also be fastened to the base of the housing 1.

FIG. 4 shows a particularly advantageous embodiment variant of the invention in the form of a built-in luminaire flush with the ceiling or the wall and having a reflector pot 14 which surrounds the luminaire member 2 on all sides with radial spacing and whose opening plane 15 extends at least substantially corresponding to the plane of the front surface 6 of the luminaire member 2. The reflector pot 14 has a base surface 16 which extends approximately parallel to the slanted surface 5 of the luminaire member 2 or also with greater steepness and which merges into a vertical wall section 33 in the vertical region of the slanted surface 5. Both the base surface 16 and the vertical wall section 33 are illuminated by light uniformly via scattering effects and reflection effects so that no shadow effects occur inside the reflector pot 14.

In a variant of the invention visible from FIG. 7 modified with respect to the embodiment shown in FIG. 4, the reflector pot 14 has a base surface 22 which is disposed in the region of the housing base, extends outwardly, ends radially within the vertical projection of the front surface 6 and is adjoined by a slanted wall region 23 which merges into a vertical wall section 33. In this respect, the angle between the housing base and the slanted wall region is preferably larger than the angle between the housing base and the slanted surface of the luminaire member disposed opposite the slanted wall region. It can be achieved by this aspect due to the resulting utilization of reflection effects that the total reflector pot, including its base surface 22, is illuminated by light uniformly and that thereby no darker or shadowed regions disturbing the esthetic appearance are present in the interior of the reflector pot 24.

In the described embodiments of built-in luminaires at the ceiling side or wall side, groups of LEDs can be provided as illuminants on a support surface 18, with the support surface 18, which is in particular reflective, being positioned in the house-side region of the radial light section 9 of the luminaire member 2. The support surface 18 can be attached to a functional component, in particular to a voltage transformer.

An esthetically high-quality appearance of the built-in lamp is achieved by the deflection of the radial light portion toward the opening side of the luminaire achieved by the reflector pot 14 and also by the diffusion light portions effective in the reflector pot. It is achieved by the different light densities between the front surface 6 to which a high direct light portion is applied and the pot region surrounding the front surface 6 that the front surface 6 appears greatly differentiated plastically so than an unmistakable characteristic overall appearance is provided.

Whereas the previously described embodiments of the invention were designed as round luminaires, FIG. 5 shows an embodiment of a built-in luminaire in rectangular or square shape. Polygonal luminaires can generally be realized in accordance with the construction principle in accordance with the invention. Compact fluorescent lamps are preferably used as the illuminants. 7. This kind of light source, however, does not represent a restriction. Depending on the design and also the size of the luminaire, the respectively best suited illuminants can be used, in particular also LEDs, optionally with a special optical attachment.

The basic design of the rectangular luminaire in accordance with FIG. 5 corresponds to the basic structure of the already described round luminaire in accordance with FIG. 4. The luminaire member 2 is releasably connected to the housing 1, which is matched shape-wise, and includes a radial light section 9, a slanted surface region 5 as well as a front surface 6.

The special feature of this embodiment, which is not restricted to rectangular luminaires, but applies in the same manner to round luminaires, consists of the fact that the luminaire member 2 is not made in one piece, but in multiple pieces, with in particular the front surface 6 being formed by a separate surface element which is made in layer shape and includes a microprism screen whose outwardly disposed prism surface is covered by an outer layer which is preferably as clear as glass and at whose inner side a diffuser foil is provided.

A much higher efficiency associated with freedom from glare is achieved by this structure in comparison with an opal glass design.

The layer structure can also be modified in dependence on the respective demands present, e.g. such that instead of a cover surface which is as clear as glass and which protects the microprism surface against contamination, a top layer is selected having especially selected light permeable properties.

The multilayer structure destined for the front surface 6 preferably has a peripheral frame 20 which can be shaped to the outer glass surface and represents a separate component which can be adhesively bonded or welded in a shape matched manner to a receiving end section 21 of the luminaire member 2.

The end section 21 adjoining the slanted surface region 5 is light permeable and forms a narrow side lighting surface supplementing the front lighting surface.

FIG. 6 shows a further embodiment of the invention in the form of a rectangular luminaire in a built-in version analog to the embodiment in accordance with FIG. 4 with a rectangular built-in trough having a marginal flange 35. Instead of a one-part luminaire member, a design is also selected in this case in which the front surface 6 is made as a separate component which is inserted into or placed onto an end section adjoining the slanted surface region 5 and has the structure already described in connection with FIG. 5.

The part sectional view in accordance with FIG. 7 shows details of the structure of a built-in luminaire designed in accordance with FIGS. 5 or 6.

The reflector pot 14 in this respect has a base surface 22 which is disposed in the region of the base of the housing 1, extends outwardly, but ends radially within the vertical projection of the front surface 6 and is adjoined by a slanted wall region 23 which merges into a vertical wall section 33 which has the customary flange 35 which engages over the respect built-in wall.

The luminaire member 2 which is again preferably made in multi-part form in this case is adhesively bonded or welded via its vertical wall section 17 to the peripheral rim of the front surface 6 which is formed by a microprism screen with which a diffuser foil is as a rule associated at the inner side and which is provided at the outer side, i.e. at the side at which the microprisms are located, with a cover 26 which is as clear as glass and which in this embodiment also extends over the vertical wall section 17 and engages over it in the manner of a hood. In this way, the marginal region formed by the vertical section 17 is designed as a light emitting surface since this vertical wall section 17 is positioned such that it is disposed in the direct light region of the respective illuminants.

The releasable connection of the luminaire member 2 and the housing 1 preferably takes place via over center lever clamps 27 which are easy to actuate and have the advantage that they are also operable via the space between the luminaire member 2 and the reflector pot 14 and are practically operable blindfold. For this purpose, a handle recess 36 is provided in the base surface.

Such a clamp consists of a bearing block 28 to be fastened to the housing 1 and at which a lever 29 is pivoted at its one end, whereas the other end of this lever 29 is pivotably supported at a longitudinally resilient actuation and latching lever 27 whose end remote from the actuation end engages over a clamping portion 32 of the luminaire body 2 and thus pulls the luminaire member 2 toward the housing 1 on the closing or clamping of the actuation lever 27. In this respect, a seal is preferably provided between the housing 1 and the luminaire member 2 which is required for the outer region and serves to prevent the penetration of dust in the inner region.

To secure the connection between the luminaire member 2 and the housing 1, which is in particular expedient on installation of the luminaire in the outer region, the clamp can be secured by means of a screw which can be introduced via a blocking opening 31 in the actuation lever 27.

To prevent the esthetic appearance of the luminaire from being impaired by the clamps, at least the portion 30 of the actuation lever 27 disposed in the region of the radial light section 9 consists of light permeable material. The actuation lever is disposed in a suitable recess of a radial luminaire surface plane in the tensioned state which extends downwardly, starting from the slanted surface 5 of the luminaire member 2, and extends flush with respect to the housing wall.

FIG. 8 shows an embodiment variant of the invention which is shown in the form of an attachment luminaire, but which can also be designed in the sense of the preceding explanations as a built-in luminaire, in which variant a multiple of mutually spaced apart LEDs 19 arranged on a support surface 18 are provided as the illuminants, with a specially designed optical attachment 37 being associated with each LED 19 and ensuring both an axial bundling and a lateral radiation of the light generated by the respective associated LED. Widely radiating LEDs, preferably LEDs with a radiation angle of approximately 120°, are use as the LEDs here. The support surface 18 for the LEDs 19 with associated optical attachment 37 is preferably positioned within the luminaire member such that at least some of the light laterally radiated from the optical attachment 39 is incident onto the radial light section 9 of the luminaire. A cover plate 38 is preferably provided adjacent to the support surface 18 and has passage openings for the optical attachment 37 consisting of elements made of light permeable material and having the shape of a truncated cone. The portion of the laterally radiated light incident as direct light onto the radial light section 9 can be influenced by the positioning of this cover plate 38.

It is of particular significance in connection with this embodiment of the invention that the number and the distribution of the LEDs on the support surface can be selected such that the axially directed light bundles are incident adjacent to one another at the front surface 6 of the luminaire or at least in an overlapping manner in the marginal regions and thus a high and uniform light density is generated at the front surface side.

The luminaire in accordance with the invention can also be made as a hanging luminaire, with in this case an at least regionally open housing base being able to be provided to achieve an additional indirect light emission via a ceiling reflection.

All the embodiments of the luminaire in accordance with the invention are also suitable as information carriers due to their areal form and can therefore be used, for example, as pictogram luminaires or house number luminaires.

### Reference Numeral List

1 housing

2 luminaire member

3 base region

4 outer region

5 slanted surface

6 front surface

7 illuminant

8 fastening section

9 radial light section

10 transition step

11 ring plate

12 coupling element

13 ring space

14 reflector pot

15 opening plane

16 base surface

17 vertical wall section

18 support surface

19 LED

20 frame

21 end section

22 base surface

23 slanted wall region

24 support region

25 prism screen

26 glass cover layer

27 clamp

28 bearing block

29 pivot lever

30 light permeable lever region

31 blocking opening

32 clamping portion

33 vertical wall section reflector pot

34 ballast

35 marginal flange

36 handle recess

37 optical attachment

38 cover plate

1. A luminaire, comprising a pot-shaped housing (1) which has a base surface and a peripheral wall
and on which illuminants (7, 19) and associated electrical components are mounted; and
into which a light permeable luminaire member (2) engages in a shape matched manner and is releasably fastened to the housing (1),
wherein the light permeable luminaire member (2) includes a base region (3) which at least substantially corresponds to an axial extension of the peripheral wall of the housing and which consists of a fastening section (8) engaging into the pot-shaped housing (1) and of a radial light section (9) disposed between the fastening section (8) and a slanted surface (5) of the luminaire member (2);
wherein furthermore the slanted surface (5) expands continuously starting from the radial light section (9) belonging to the base region (3) and merges either directly or via a vertical wall section (17) into a shaped surface (6) extending approximately perpendicular to the central axis of the luminaire member;
and the slanted surface (5) includes an angle less than 50° with the base surface of the housing (1);
and the illuminant or illuminants (7, 19) is or are positioned and/or mounted beneath the cross-sectional plane corresponding to the start of the slanted surface (5) such that both the radial light section (9) and the front surface (6) are illuminated with direct light by the illuminants (7, 19) substantially over their whole area and the total slanted surface (5) is substantially only disposed in the sidelight region of the illuminants (7, 19) to achieve a lower light density in comparison with the front surface (6) and with the radial light section (9).

2. A luminaire in accordance with claim 1, characterized in that the illuminants (7, 19) are disposed beneath the start of the cross-sectional plane corresponding to the radial light section (9) disposed before the slanted surface (5).

3. A luminaire in accordance with claim 1, characterized in that the axial height of the radial light section (9) is smaller than the axial height of the slanted surface section (5) extending up to the front surface (6).

4. A luminaire in accordance with claim 3, characterized in that the axial height of the radial section (9) amounts to 30% to 60% of the height of the slanted surface section.

5. A luminaire in accordance with claim 1, characterized in that the slanted surface (5) includes an angle in the range from approximately 25 to 45° with the base surface of the housing (1).

6. A luminaire in accordance with claim 1, characterized in that a transition is provided between the fastening section (8) and the radial light section (9) in the form of a step (10), in particular a right-angled step, associated with an increase in diameter.

7. A luminaire in accordance with claim 1, characterized in that a ring plate (11) is positioned in the region of the radial light section (9) and with a presettable axial spacing with respect to the slanted surface (5), said ring plate extending at least substantially parallel to the front surface (6) and its diameter being larger than the diameter of the front surface (6).

8. A luminaire in accordance with claim 6, characterized in that the ring plate (11) is arranged at the level of the transition step (10) between the fastening section (8) and the radial light section (9) and is connected to the housing (1) via coupling elements (12).

9. A luminaire in accordance with claim 8, characterized in that the radially inner region (24) of the ring plate (11) is made as an at least partly open, light permeable region.

10. A luminaire in accordance with claim 7, characterized in that the ring plate (11) is made as a top wall of a ring space (13) at least partly surrounding the housing (1) for the reception of electronic units, e.g. a motion detector or ballast.

11. A luminaire in accordance with claim 1, characterized by a design in the form of a built-in luminaire flush with a ceiling or a wall and having a reflector pot (14) which surrounds the luminaire member (2) on all sides with radial spacing and whose opening plane (15) extends at least substantially corresponding to the plane of the front surface (6) of the luminaire member (2).

12. A luminaire in accordance with claim 11, characterized in that the reflector pot (14) has a base surface (16) which extends, starting from the upper end region of the housing (1), at a presettable angle and preferably approximately parallel to the slanted surface (5) of the luminaire body (2) and which merges in the vertical region of the slanted surface (5) into a vertical wall section (33).

13. A luminaire in accordance with claim 11, characterized in that the reflector pot (14) has a base surface (22) which is disposed in the region of the housing base, extends radially outwardly, ends inside the vertical projection of the front surface (6) and is adjoined by a slanted wall region (23) which merges into a vertical wall section (33).

14. A luminaire in accordance with claim 13, characterized in that the angle between the housing base and the slanted wall region (23) is larger than the angle between the housing base and the slanted surface (5) of the luminaire member (2) disposed opposite the slanted wall region (23).

15. A luminaire in accordance with claim 13, characterized in that the angle between the housing base and the slanted wall region (23) is smaller than the angle between the housing base and the slanted surface (5) of the luminaire member (2) disposed opposite the slanted wall region (23).

16. A luminaire in accordance with claim 1, characterized in that fluorescent lamps, in particular of ring or rod shape, positioned in the region and at the level of the fastening section (8) of the luminaire member (2) or compact fluorescent laps with at least four light rods are provided as the illuminants (7).

17. A luminaire in accordance with claim 1, characterized in that LEDs (19), in particular monochromatic LEDs, arranged on at least one support surface (18) are provided as illuminants (7), with the support surface (18) being positioned in the region of the radial light section (9) of the luminaire member (2) at the housing side.

18. A luminaire in accordance with claim 17, characterized in that the support surface (18) is reflective.

19. A luminaire in accordance with claim 1, characterized in that the luminaire member (2) is made as a round luminaire or polygonal luminaire, in particular a rectangular luminaire, and an optionally associated reflector pot (14) is matched in its shape.

20. A luminaire in accordance with claim 19, characterized in that the luminaire member (2) consists of opal glass or of a plastic material effective in a technical light manner.

21. A luminaire in accordance with claim 19, characterized in that the luminaire member (2) comprises a plurality of parts, in particular adhesively bonded or welded together, with at least the front surface (6) including a layer structure having a microprism screen whose outwardly disposed prisms are covered by an outer surface which is preferably as clear as glass and at whose inner side a diffuser foil is preferably provided.

22. A luminaire in accordance with claim 21, characterized in that the layer structure forming the front surface (6) can be connected in a shape matched manner to the matched free end section (21) of the luminaire member (2) directly or via a frame (20) surrounding the layer structure and preferably made in one part with the outer surface, which is as clear as glass, to form a unit.

23. A luminaire in accordance with claim 21, characterized in that the region of the luminaire member (2) adjoining the front surface (6) and preferably formed by the end section (21) forms a peripheral, in particular opal lighting surface.

24. A luminaire in accordance with claim 1, characterized in that the luminaire member (2) is fastened to the housing (1) via over center lever clamps (27) supported at the housing (1) and in particular accessible via the space between the luminaire member (2) and the reflector pot (14).

25. A luminaire in accordance with claim 24, characterized in that the over center lever clamps (27) are arranged externally flush in cut-outs of the housing (1) and of the radial light section (9) in the clamped state.

26. A luminaire in accordance with claim 24, characterized in that at least the part of the clamp (27) extending over the level of the radial light section (9) is light permeable.

27. A luminaire in accordance with claim 1, characterized in that a plurality of mutually spaced apart LEDs (19) arranged in a plane parallel to the front surface (6) of the luminaire member (2) are provided as illuminants (7);
in that an optical attachment (37) is associated with each LED (19) and effects both an axial bundling and a lateral radiation of the light; and
in that the LEDs (19) with the associated optical attachment (33) are positioned preferably at least partly in the base region (3) of the luminaire member (2).

28. A luminaire in accordance with claim 27, characterized in that widely radiating LEDs having a radiation angle of preferably approximately 120° are used as the LEDs (19).

29. A luminaire in accordance with claim 27, characterized in that the number and distribution of the LEDs (19) with optical attachment (37) are selected such that the axially directed light bundles are incident on the front surface (6) substantially adjacent to one another or overlapping one another in the marginal regions.

30. A luminaire in accordance with claim 27, characterized in that the elements forming the optical attachment (37) and made of light permeable material are designed in truncated cone shape and the associated LEDs (19) are arranged centrally at the end of the elements having the smaller diameter.
